(19) United States
(12) Patent Application Publication
(10) Pub. No.: US 2004/0247791 A1
(43) Pub. Date: Dec. 9, 2004

(54) Method for preparing nanocrystalline ceramic thin films

(75) Inventors: Michael Z. Hu, Knoxville, TN (US); Junhang Dong, Los Lunas, NM (US)

Correspondence Address: UT-Battelle, LLC, Office of Intellectual Property, One Bethal Valley Road, 4500N, MS-6258, Oak Ridge, TN, 37831, US

(73) Assignee: United States Department of Energy

(21) Appl. No.: 10/453,704

(22) Filed: Jun. 3, 2003

(51) Int. Cl. B05D 3/02

(52) U.S. Cl. 427/372.2; 427/430.1

(57) ABSTRACT

A method for preparing nanocrystalline ceramic thin films, particularly at low firing temperatures <1000° C. The method for preparing ceramic thin films comprises preparing a seed gel of metal oxide, dissolving a source compound for cations of the oxide's metal constituents in the solution, then adding a polymerizable organic solvent to the solution and heating to form a polymeric precursor having uniformly dispersed gel seeds within a solid gel structure whereby any voids within the structure are filled with metal cation-containing polymeric precursor. The polymeric precursor is free of precipitates. A surface of a substrate is then coated with at least one layer of the gel-seeded polymeric precursor to form a uniform film of gel-seeded polymeric precursor wherein the film has a thickness of 100 nm to 200 nm per layer. The film is then sintered to convert the film to a nanocrystalline ceramic thin film having a thickness of 100 nm to 1 μm and being substantially free of defects.

The invention was made with government support under contract no. DE-AC05-00OR22725 awarded by the United States Department of Energy to UT-Battelle, LLC., and the government has certain rights in the invention.

### FIELD OF THE INVENTION

The present invention relates to the field of ceramic thin films and methods for synthesizing such thin films, particularly a method for synthesizing nanocrystalline ceramic thin films at low firing temperatures.

### BACKGROUND OF THE INVENTION

Nanocrystalline (<100 nm grain size) metal oxide and metal oxide complex thin films have shown substantially enhanced properties such as high electrical and ionic conductivities at relatively lower temperatures compared to the films with grain size >100 nm. This creates opportunities to develop new types of nanostructured, high-efficiency solid oxide fuel cells (SOFC), sensors, and membrane reactors. The major obstacles for large-scale application of these nanostructured materials lie in the difficulty in efficient preparation of good quality of thin film layer on substrate surface and the difficulty in stabilizing the microstructure in the conventional production processes such as pressurized sintering and tape casting-sintering. Other methods like laser pulse deposition, CVD, and sputtering coating, etc., have unacceptable high cost, requirement of high pressure or vacuum, as well as the technical problems associated with the control of the stoichiometry. A recently reported polymeric precursor coating method by Anderson et al. (U.S. Pat. No. 5,494,700), incorporated herein by reference, showed advantages in orders of magnitude of higher conductivity in derived polycrystalline film due to microstructure stabilization and the control of the stoichiometry. However, this polymeric precursor spin-coating method has low efficiency in film coating (20 nm-thick film per coating step) and requires as many as 50 times of coating to achieve a 1 um-thick film, which increases the fabrication cost. The high number of coating steps also increases the chance of inducing impurity and defects during the coating and drying processes.

The method of the present invention achieves a film thickness of 100-200 nm per coating and maintains the advantages of the pure polymeric precursor approach. Such a significant improvement in coating can substantially lower the synthesis cost and improve the quality of thin films.

### OBJECTS OF THE INVENTION

Accordingly, it is an object of the present invention to provide a more cost efficient method for synthesizing nanocrystalline ceramic thin films, particularly metal oxide thin films having improved quality.

It is another object of the present invention to provide a method for synthesizing dense, nanocrystalline ceramic thin films, particularly metal oxide thin films at low firing temperature.

It is yet another object of the present invention to provide a method for synthesizing dense, nanocrystalline ceramic thin films and particularly metal oxide thin films by using sol-gels in polymeric precursor solutions, eliminating the needs of ball milling of ceramic powders.

It is still yet another object of the present invention to provide a method for synthesizing defect-free, nanocrystalline ceramic thin films and particularly metal oxide thin films for use in high efficiency solid oxide fuel cells, gas sensors, oxygen generators, and oxidative membrane reactors.

Further and other objects of the present invention will become apparent from the description contained herein.

### SUMMARY OF THE INVENTION

In accordance with one aspect of the present invention, the foregoing and other objects are achieved by a method for preparing ceramic thin films comprising the steps of first preparing a seed gel of metal oxide; then, dissolving a source compound for cations of the oxide's metal constituents in the metal oxide seed gel. Then, a polymerizable organic solvent is added to the seed gel and heated to form a polymeric precursor having uniformly dispersed gel seeds within a solid gel structure whereby any voids within the solid gel structure are filled with metal cation-containing polymeric precursor. The polymeric precursor is free of precipitates. Then, a surface of a substrate is coated with at least one layer of gel-seeded polymeric precursor to form a uniform film of the gel-seeded polymeric precursor thereon the substrate, the film having a thickness of 100 nm to 200 nm per layer. The substrate having a gel-seeded polymeric precursor film is then sintered to convert the film to a nanocrystalline ceramic thin film wherein the nanocrystalline ceramic thin film has a thickness of 100 nm to 1 μm and is substantially free of defects.

### BRIEF DESCRIPTION OF THE DRAWINGS

FIG. 1 shows the evolution of the XRD pattern for the gel-seeded precursor film during firing process (heating rate 2° C./min.).

FIG. 2 shows the change in grain size during the firing process offering a comparison between the gel-seeded and unseeded precursor films wherein the heating rate is 2° C./min. for both films and wherein both films are supported on silicon wafers.

FIG. 3 shows the average grain size vs. annealing temperature for MGO supported films wherein annealing time is 20 hours for all experiments.

FIG. 4 is a cross-sectional SEM image of a silicon wafer-supported YSZ film prepared from gel-seeded precursor, annealed at 1000° C. for 20 hours.

FIG. 4a is a surface SEM image of the silicon wafer-supported YSZ film in FIG. 4.

### DETAILED DESCRIPTION OF THE INVENTION

The present invention provides a new approach for synthesis of defect-free, nanocrystalline ceramic, and particularly, metal oxide thin films, on dense and porous ceramic substrates. The method of the present invention has higher fabrication efficiency and better cost-effectiveness in preparing thin films of target thickness (100 nm to 1 μm). The synthesis method of the present invention comprises three major steps. The first step involves preparing a precipitate-free, polymeric precursor seeded with uniformly dispersed gel seeds. The amorphous gel seeds are synthesized by sol-gel reactions or other gel forming reactions. The gel seeds are well dispersed and stabilized in a polymeric precursor solution during the polymerization process. The second step comprises coating the gel-seeded polymeric precursor on dense or porous ceramic substrates by a spin-coating or dip-coating technique. The third step comprises drying the coated layer of amorphous gel-polymer and subsequently converting the dried precursor layer to a homogeneous nanocrystalline, ceramic dense film by firing in air at temperatures ranging from 750° to 1100° C. This synthesis method is able to obtain a film thickness of 100-200 nm in a single coating step, which is much more efficient than the reported pure polymeric precursor approach, which yields a film thickness of about 20 nm per coating step. The high efficiency of the present invention is attributed to the ability of the gel-seeds to form a solid gel skeleton in which the voids are filled with metal cation-containing polymeric precursor. The microstructure of the resulting film (i.e., nanograin size and film density) obtained by the new method is comparable to that of the film prepared by the pure polymeric precursor approach. The method of the present invention eliminates the unnecessary use of ceramic powders and the energy-intensive ball milling procedures for refining/dispersing aggregated ceramic powders. The method of the present invention can be used to synthesize nanocrystalline thin films of ceramics, in particular, metal oxides such as yttrium-stabilized zirconia, ceria, and perovskite type metal oxide complexes, which have great potential to be used in high efficiency solid oxide fuel cells, gas sensors, oxygen generators, and oxidative membrane reactors.

The first step is to prepare a highly stable, gel-seeded polymeric precursor solution starting from a metal oxide gel such as prepared from sol-gel reactions, such as zirconia sol-gel, dissolving a source compound for cations of the oxide's metal constituents with the metal oxide gel, and adding a polymerizable organic solvent. Suitable organic solvents include those having carbonyl functional groups capable of polymerization. Preferably, the organic solvent is ethylene glycol. The cation source compounds suitable for use in the present invention are those which exhibit substantial solubility in aqueous solutions and include nitrates, chlorides, carbonates, alkoxides and hydroxides of the appropriate metals in addition to the metals themselves. Preferably, the cation source compounds are nitrates, chlorides or carbonates, either hydrated or anhydrous, since these compounds are relatively inexpensive, easily accessible, and readily soluble in aqueous solutions.

The amorphous wet gels can be made by various methods including sol-gel (Kim and Lin, 1998, incorporated herein by reference), forced hycrolysis, dielectric tuning solution (DTS) synthesis (Hu et al., 2000, incorporated herein by reference), chemical precipitation and others. For one example, the zirconia sol-gel is prepared by controlled hydrolysis of zirconium n-propoxide followed by refluxing and peptizing in acidic (HNO₃) conditions. For making a precursor of YSZ with 16 mol % Y doping level, 20 ml zirconia sol-gel (1.0˜2.5 wt. %) is mixed with a determined volume of yttrium nitrate solution (0.1 M) to constitute a Zr/Y atomic ratio of 84/16. Then 5.4128 g zirconyl chloride hydrate (ZrOCl₂-8H₂O), 2.4513 g yttrium nitrate hydrate (Y(NO₃)₃-6H₂O) and 1.5 g glycine (0.02 mole) are dissolved in the ZrO₂ sol-gel sequentially. This ZrO₂ sol-gel is added to 40-ml of ethylene glycol. The final sol (i.e., mixed gel and polymeric precursor solution) is placed in a convection oven and heated to the range of 70-90° C. for times of 65 to 120 hr. A precipitate-free, gel-seeded polymeric precursor solution is obtained. This gel-seeded precursor is colloidally stable and usable within at least two months after preparation.

The starting gel-seeded polymeric precursor solution is heated to expel water and other volatile components and to form a viscous gel-seeded polymeric precursor comprising a polymer containing the metal cations. It is critical that the cations remain in solution throughout the polymerization process. The formation of precipitates may lead to inhomogeneities and a non-uniform metal distribution in the resulting oxide as well as lead to the formation of cracks or pinholes in the oxide film. Precipitation is prevented by controlling the pH of the precursor solution. The specific pH range of a precursor solution, which will prevent precipitation upon polymerization, is dependent upon the particular metal oxide system and may be determined experimentally. This can be done by preparing several samples of the polymeric solution for a particular metal oxide system, each sample varying incrementally in pH, and then observing which polymeric precursor solution(s) yield a precipitate-free precursor upon subsequent heating.

The pH of the polymeric precursor can be varied, for example, by adding a neutral, acidic or basic pH control agent to the polymeric solution. An example of a suitable neutral pH control agent and is the preferable pH control agent is glycine. Examples of suitable acidic pH control agents include: nitric acid, hydrochloric acid, citric acid and oxalic acid. Examples of suitable basic pH control agents include: ammonium hydroxide and ethylene diamine. Although citric acid and ethylene diamine may be added to the polymeric solution to control pH, these two pH control agents are less preferred because they are believed to promote cross-linking in the polymeric precursor. Cross-linking in the polymeric precursor may lead to non-uniform shrinkage of the film upon subsequent heat treatrnent, resulting in cracking of the oxide film.

The second step is to form a thin and uniform precursor layer on a solid substrate surface. A drop of the get-seeded polymeric precursor is deposited or placed at the center of the substrate, and then a two-stage spin-coating process is used to form a precursor film layer. The two stages of spinning are: 5-10 s spinning at 500-1000 rpm for the first stage and 20-30 s spinning at 2000-3000 rpm for the second stage. The coated substrate is dried sequentially at 80° C. in a convection oven and 270° C. on a heating surface, respectively, 1-2 min at each temperature. Drying of the deposited film can be carried out using any suitable heating apparatus such as a hot plate, laboratory oven or infra red lamp.

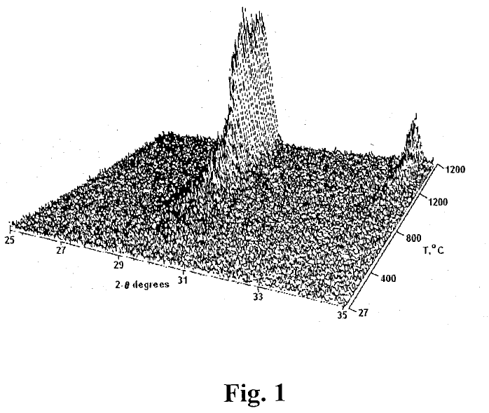

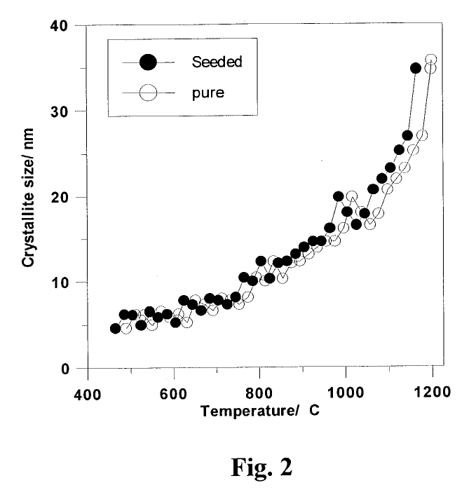

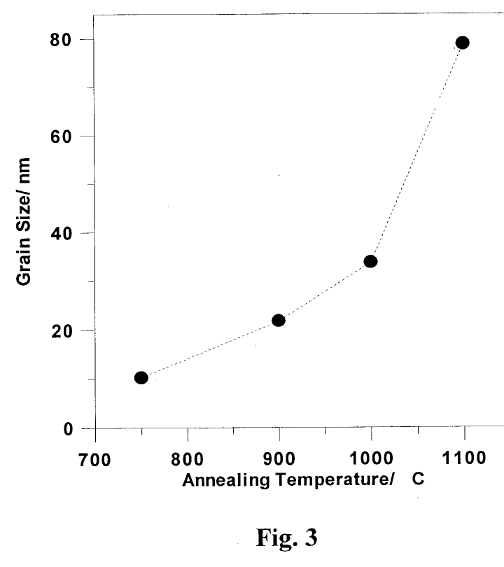

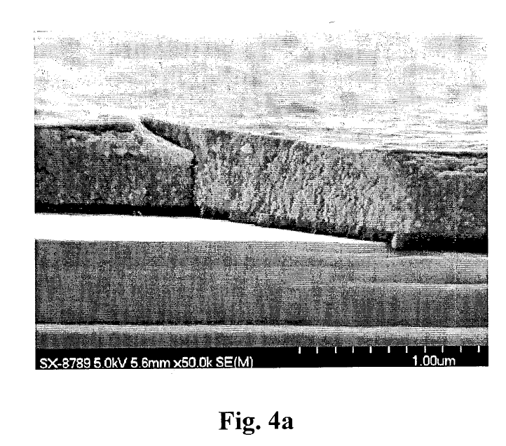

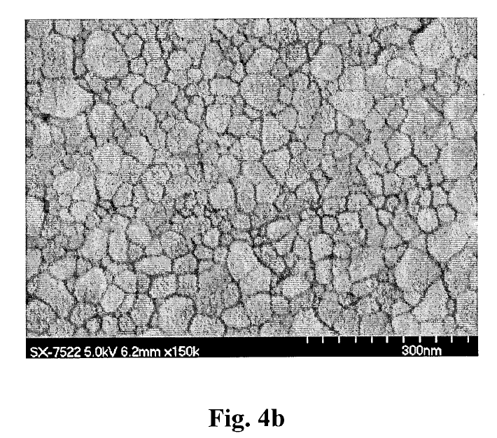

The third step is to convert the amorphous gel-polymeric precursor film layer to a nanocrystalline thin film by heat treatment at 800-1100° C. in a furnace. Crack- and pinhole-free ceramic films can be obtained using various heating rate, 0.5-10° C./min. FIG. 1 shows the evolution of the XRD pattern and FIG. 2 shows the crystallite grain size change of the YSZ film during the firing process, a comparison between the seeded and unseeded precursor films. Heating rate is 2° C./min for both films and both films are supported on silicon wafers. FIG. 3 gives the average grain size change with the annealing temperature for MgO supported films. Annealing time is 20 hours for all experiments. The final YSZ film thickness can be controlled by varying the number of coating steps. FIG. 4a and FIG. 4b are the SEM images showing a cross-section and surface of a silicon wafer-supported YSZ film prepared from seeded precursor (annealed at 1000° C. for 20 hours). A three-step coating process prepared the film with a final thickness of 0.5 μm.

Example 1 is a detailed procedure for the synthesis of nanocrystalline YSZ thin films on flat sheet substrates (Silicon substrates were used (001 orientation), Silicon Sense, Inc.) by the gel-seeded polymeric precursor approach of the subject invention.

### EXAMPLE 1

Step 1. Preparation of seeded polymeric precursor. First, a zirconia sol-gel was prepared by adding 123 ml of zirconium n-propoxide (Alfa, Mw=327.56 g/mole, 70 purity, 0.25 mole=116.98 g 123 ml) into 500 ml of anhydrous isopropanol with stirring at room temperature and in water-free atmosphere (in nitrogen box). Then, the solution was added dropwise to 900 ml deionized water with stirring at 70° C. and last 1-2 hours. A white sol-gel precipitate formed. Then, the solution was filtered with vacuum suction and the precipitate was washed in water several times. The product was diluted in 1 liter of water and peptized with 125 ml of 1 M HNO₃ solution, followed by refluxing at 90°-100° C. over night with stirring. The sol-gel was re-dispersed in an ultrasonic bath for 30 minutes before use.

For making a precursor of YSZ with 16 mol % Y doping level: 20 ml of stable zirconia sol-gel (1.6 wt. % solid) was taken from the upper layer of the sol-gel, after being strongly stirred for 3 hours and then statically placed for 3-days, and mixed with 5 ml of yttrium nitrate solution (2 g yttrium nitrate in 100 ml 0.05 M HNO₃) wherein the amount of Y(NO₃)₃ solution was verified to get a Zr/Y mole ratio of 0.84/0.16). The sol-gel was further dispersed in ultrasonic bath for 60 minutes.

Then, 5.4138 g zirconyl chloride hydrate (ZrOCl₂-8H₂O) (99.99%, Aldrich) and 2.4513 g yttrium nitrate hydrate (Y(NO₃)₃-6H₂O) (Aldrich) were dissolved in the prepared sol-gel. This gave 0.02 mole of oxides (in the polymeric precursor alone) with a Zr/Y molar ratio of ˜0.84/0.16. Then, 1.5 g glycine (99+%, Aldrich) (0.02 mole) was added into the solution and stirred for 40 minutes. Next, 40 ml of ethylene glycol (99+%, Aldrich) was added into the solution with vigorous stirring, a clear, precipitate-free solution was obtained, free of particle settlement. The solution was then placed in an oven with the temperature controlled at 80° C. for 65-120 hours to expel the water and polymerize the solution. No solid settlement was observed during the polymerization process. The polymerized solution, having sol-gel seeds, was removed from the oven, cooled down and kept at room temperature while covered for 2-4 hours. Here, the polymerizable organic solvent is ethylene glycol. Glycine was a pH control agent (6<pH<7) used to inhibit the formation of precipitates during polymerization upon heating. The resultant polymeric precursor molecules are polyethylene glycol chelated with metal ions.

Step 2. Spin coating. One drop of the gel-seeded polymeric solution was placed at the center of the silicon substrate surface (dimensions of 15×15×0.5 mm). Then the film was prepared by a two-stage spin-coating process using a two-stage spin-coater (KW-4A, Chemat Technology, Calif.). The first stage had a rotation speed of 700 rpm (500-1000 rpm) for 5-10 seconds, then the second stage, 2500 rpm (2000-3000 rpm) for 25 seconds (20-30 seconds). The first stage of spinning spread the liquid precursor droplet over a large area that avoided slippage of the precursor from the substrate before a uniform film was formed at the second-stage high-speed spinning that determined the thickness of the coated layer. The coated silicon wafer substrate was then dried at 80° C. on a metal plate preheated in a convection oven for 1-2 minutes. This low-temperature drying step removed the remaining volatile components such as water and ethylene glycol monomer, which could have formed bubbles when heated and evaporated rapidly at higher temperatures. The film was then further heated at 270° C. for 1-2 minutes to obtain a strong and completely dry precursor layer. A second spin-coated layer was applied after the film was dried at 270° C., followed by the same two-step drying processes.

Step 3. Sintering to convert the precursor film to a dense nanocrystalline thin film. The film was sintered in a firnace at high temperature to convert the gel-polymeric precursor layer to nanocrystalline films with a three-step program. First, the coated substrate was heated from room temperature to 700° C. (800-1100° C.) at a heating rate of 0.5-10° C./min. The temperature (800°-1100° C.) was held for 3-10 hours. Finally, the film was cooled to room temperature at a cooling rate of 1-10° C./min.

The preferred method of the present invention offers high efficiency in the formation of dense, nanocrystalline metal oxide films at low firing temperature (<1000° C.) wherein the films have 100-200 nm oxide film thickness per single spin-coating due to the high solid content in the gel-seeded polymeric precursor solutions. However, the method of the present invention maintains the nanosized grains up to 1100° C. for up to 10 hours. The present invention requires less number of coatings to achieve the desired thickness of films thereby reducing the chance of film cracking and defect—introduction during coating and drying steps. The concept of combining sol-gels with polymeric precursor solutions apply to the formation of nanocrystalline ceramic films, without the need of ceramic powders that typically require difficult dispersion such as by ball milling. Dispersion of agglomerated ceramic powders into nanometer sized particles is extremely hard to achieve. This difficulty is by-passed with the method of the present invention by the utilization of sol-gels. The method of the subject invention can be used to synthesize any metal oxide or other ceramic nanocrystalline film, such as zirconia, ceria and other metal oxide, including complex mixed metal-oxides films (i.e., oxides containing more than one cation constituent) having different dopants. In addition to YSZ, other exemplary metal oxides which can be produced as thin films by the method of the present invention and which have particular application as components in intermediate temperature SOFCs include LSM, LSCF, etc. Other metal oxides and ceramics which can be produced as thin films by the method of the present invention include: NiO, MgO, Al₂O₃, CaO, SrO, BaO, TiO₂, Cr₂O₃, MnO₂, Fe₂O₃, CuO, ZnO, Y₂O₃, Zro₂, Nb₂O₅, SnO₂, LaO₃, CeO₂, Sm₂O₃, nitrides, carbides and combinations thereof.

In addition to the sol-gel method, the seeded dispersable gels can also be synthesized by many other conventional or new methods. Commercially available gels and dispersible gels can also be used as a seed sol to be added with a polymeric precursor solution. Solid (gel seed) content of the polymeric precursor may be varied from 1 wt % to 5 wt % to change the thickness of single coating films. The crystallite size in the final films may be controlled by varying the sintering temperature and initial seed size.

While there has been shown and described what are at present considered the preferred embodiments of the invention, it will be obvious to those skilled in the art that various changes and modifications can be made therein without departing from the scope of the invention defined by the appended claims.

What is claimed is:

1. A method for preparing nanocrystalline ceramic thin films comprising the steps of:
a) preparing a seed gel of metal oxide;
b) dissolving a source compound for cations of said oxide's metal constituents in said seed gel;
c) adding a polymerizable organic solvent to said seed gel;
d) heating said gel of step c) to form a polymeric precursor having uniformly dispersed gel seeds within a solid gel structure whereby any voids within said solid gel structure are filled with metal cation-containing polymeric precursor, said polymeric precursor being free of precipitates;
e) coating a surface of a substrate with at least one layer of said gel-seeded polymeric precursor to form a uniform film of said gel-seeded polymeric precursor, said film having a thickness of 100 nm to 200 nm per layer; and
f) sintering said film of said gel-seeded polymeric precursor to convert said film to a nanocrystalline ceramic thin film, said nanocrystalline ceramic thin film having a thickness of 100 nm to 1 μm and being substantially free of defects.

2. The method of claim 1 wherein said seed gel of metal oxide is a sol solution.

3. The method of claim 1 wherein said seed gel of metal oxide is a colloidal suspension.

4. The method of claim 1 wherein said seed gel is an amorphous gel.

5. The method of claim 6 wherein said metal oxide is selected from the group consisting of zirconia, ceria, yttrium-stabilized zirconia, NiO, MgO, Al₂O₃, CaO, SrO, BaO, TiO₂, Cr₂O₃, MnO₂, Fe₂O₃, CuO, ZnO, Y₂O₃, ZrO₂, Nb₂O₅, SnO₂, LaO₃, CeO₂, Sm₂O₃, nitrides, carbides and mixed oxide combinations thereof.

6. The method of claim 1 wherein said polymerizable organic solvent is ethylene glycol.

7. The method of claim 1 wherein said source compound for cations are nitrates, chlorides or carbonates of said oxide's metal constituents.

8. The method of claim 1 wherein a pH control agent is selected from the group consisting of nitric acid, citric acid, hydrochloric acid, glycine, ammonium hydroxide and ethylene diamine is added to said solution of step c) to inhibit the formation of precipitates.

9. The method of claim 1 wherein said film is sintered at a low firing temperature of <1000° C.

10. The method of claim 1 wherein the nanocrystalline grain size of said nanocrystalline ceramic thin film is maintained at temperatures up to 1100° C.

11. The method of claim 1 wherein said coating step comprises spin coating or dip coating.
